(19) United States
(12) Patent Application Publication
(10) Pub. No.: US 2025/0002827 A1
(43) Pub. Date: Jan. 2, 2025

(54) Films and Their Use in Home Care Compositions

(71) Applicant: Colgate-Palmolive Company, New York, NY (US)

(72) Inventors: Lucero Arantxa CARDENAS DAVALOS, Ciudad de Mexico (MX); Carolina Bermudez Salguero, Mexico City (MX); Sandra Paola Sanchez, Mexico City (MX); Luis Miguel Lopez, Mexico City (MX); Federico Daniel Sandoval, Mexico City (MX)

(73) Assignee: Colgate-Palmolive Company, New York, NY (US)

(21) Appl. No.: 18/759,942

(22) Filed: Jun. 30, 2024

Related U.S. Application Data
(60) Provisional application No. 63/524,367, filed on Jun. 30, 2023.

(51) Int. Cl. C11D 17/06; C11D 1/29; C11D 1/40; C11D 1/65; C11D 1/66; C11D 1/75; C11D 1/83; C11D 1/90; C11D 1/94; C11D 3/20; C11D 3/22; C11D 3/50

(52) U.S. Cl. CPC C11D 17/06; C11D 1/29; C11D 1/40; C11D 1/65; C11D 1/662; C11D 1/75; C11D 1/83; C11D 1/90; C11D 1/94; C11D 3/2044; C11D 3/222; C11D 3/50

(57) ABSTRACT

Home care compositions and films formed therefrom are disclosed herein. In accordance with an aspect of the invention, provided is a home care composition including a polysaccharide comprising a pullulan, an alginate, or a combination thereof; optionally, a cellulose; a polyol; one or more surfactant comprising an anionic surfactant, a betaine surfactant, a nonionic surfactant, or a combination of two or more thereof; optionally a fragrance; and optionally an emollient, wherein the home care composition is in the form of a film.

### CROSS-REFERENCE TO RELATED APPLICATIONS

This application claims the benefit of priority from U.S. Patent Application No. 63/524,367, filed Jun. 30, 2023, titled Films and Their Use in Home Care Compositions, the content of which are hereby incorporated herein in their entireties, for all purposes.

### BACKGROUND

Cleaning products are commonly offered to consumers in ready to use form. Cleaning products such as glass cleaners and hard surface cleaners are commonly offered in spray bottles or liquid containers commonly ranging in size from one quart to one gallon. Some of these cleaning products can be refilled. Such refill containers are typically larger than the container that is used by the consumer. As such, the cleaning product and refill, if available, can take up significant shelf space in a consumer's household.

Laundry cleaners are generally offered in liquid or granular form. Liquid laundry cleaners are commonly offered in liquid containers generally ranging in size from one quart to one gallon. Similar to other types of cleaning products, the laundry detergent container can take up significant shelf space in both a consumer's household.

Other types of supplemental or specialty cleaners such as laundry stain removers, laundry detergent and/or bleaching additives, spot carpet cleaners, carpet odor removers, toilet bowl cleaners, tile cleaners, drain cleaners and the like are commonly offered to consumers in aerosol cans or liquid containers that are typically about one quart to half gallon sized containers. All of these different cleaning products require a large amount of shelf space in a consumer's home.

In addition, the weight of all these cleaning products on certain types of shelving systems can result in damage to the shelf system. Furthermore, the weight of the container can make it difficult for a consumer to hold, carry, lift, remove from a shelf, and restore on a shelf. Although the offering of certain types of cleaning products in liquid concentrated form can result in a reduction in the size of the cleaning product container, many concentrates are offered to consumers in the same container size, but offer more uses per container due to the concentrated form of the cleaner. As such, the shelf spacing and weight issues of such cleaners is not addressed by concentrated cleaning liquids.

Additionally, consumers are becoming more conscious of the sustainability and water usage associated with consumer products.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

Aspects of the invention are directed to home care compositions and films formed therefrom. In accordance with an aspect of the invention, provided is a home care composition including a polysaccharide comprising a pullulan, an alginate, or a combination of two or more thereof; optionally, a cellulose; a polyol; and one or more surfactant comprising an anionic surfactant, a betaine surfactant, a nonionic surfactant, or a combination of two or more thereof, wherein the home care composition is in the form of a film.

In accordance with another aspect of the invention, provided is a home care composition comprising an alginate; a cellulose; a polyol; and one or more surfactant comprising a betaine surfactant, an anionic surfactant, or a combination of two or more thereof, wherein the home care composition is in the form of a film.

In accordance with a further aspect of the invention, provided is a home care composition consisting of one or more cellulose; one or more alginate; one or more polyol; one or more betaine surfactant; optionally one or more anionic surfactant; and optionally one or more preservative, wherein the home care composition is in the form of a film.

In accordance with an additional aspect of the invention, provided is a home care composition including a pullulan; a cellulose; a polyol; and one or more surfactant comprising a betaine surfactant, an anionic surfactant, or a combination of two or more thereof, wherein the home care composition is in the form of a film.

In accordance with yet another aspect of the invention, provided is a home case composition consisting of one or more cellulose; one or more pullulan; one or more polyol; one or more betaine surfactant; optionally an anionic surfactant; and optionally one or more preservative, wherein the home care composition is in the form of a film.

In accordance with a further aspect of the invention, provided is a home case composition comprising one or more cellulose; one or more pullulan; one or more polyol; one or more betaine surfactant; one or more emollient (e.g., flaxseed); optionally an anionic surfactant; and optionally one or more preservative, wherein the home care composition is in the form of a film.

A list of non-limiting example embodiments in accordance with aspects of the invention is provided below:

In accordance with an embodiment 1, provided is a home care composition comprising: a polysaccharide comprising a pullulan, an alginate, or a combination thereof; optionally, a cellulose; a polyol; one or more surfactant comprising an anionic surfactant, a betaine surfactant, a nonionic surfactant, or a combination of two or more thereof; optionally, a fragrance; and optionally, an emollient, wherein the home care composition is in the form of a film.

In accordance with embodiment 2, provided is the home care composition according to embodiment 1, wherein the polysaccharide is present in an amount from about 3 to about 21 wt. %, based on the total weight of the home care composition.

In accordance with embodiment 3, provided is the home care composition according to embodiment 1 or embodiment 2, wherein the polysaccharide further comprises chitosan, maltodextrin, pectin, xanthan gum, guar gum, gum arabic, algin, or a combination of two or more thereof.

In accordance with embodiment 4, provided is the home care composition according to embodiment 1, wherein the cellulose is a cellulose fiber.

In accordance with embodiment 5, provided is the home care composition according to embodiment 1, wherein the cellulose has a diameter of about 1 micron to about 100 μm.

In accordance with embodiment 6, provided is the home care composition according to any foregoing embodiment, wherein the cellulose is selected from microcrystalline cellulose, hydroxypropylcellulose, hydroxypropylmethylcellulose, hydroxyethylcellulose, methylcellulose, carboxymethylcellulose, sodium carboxymethylcellulose, and a combination of two or more thereof.

In accordance with embodiment 7, provided is the home care composition according to any foregoing embodiment, wherein the polyol is present in an amount from about 1 to about 30 wt. %, based on the total weight of the home care composition.

In accordance with embodiment 8, provided is the home care composition according to any foregoing embodiment, wherein the polyol is selected from ethylene glycol, propylene glycol, butylene glycol, hexylene glycol, glycerin, diglycerin, diethylene glycol, and dipropylene glycol, and a combination of two or more thereof.

In accordance with embodiment 9, provided is the home care composition according to any foregoing embodiment, wherein the surfactant system is present in an amount from about 5 to about 35 wt. %, based on the total weight of the home care composition.

In accordance with embodiment 10, provided is the home care composition according to any foregoing embodiment, wherein the one or more surfactant is present in an amount from about 20 to about 70 wt. %, based on the total weight of the home care composition.

In accordance with embodiment 11, provided is the home care composition according to any foregoing embodiment, wherein the surfactant system comprising an anionic surfactant selected from sodium lauryl sulfate, sodium dodecyl sulfate, sodium lauryl ether sulfate, ammonium lauryl sulfate, ammonium laureth sulfate, and a combination of two or more thereof.

In accordance with embodiment 12, provided is the home care composition according to any foregoing embodiment, wherein the surfactant system comprises a betaine surfactant selected from cocoamidopropyl betaine, laurylamidopropyl betaine, and a combination thereof.

In accordance with embodiment 13, provided is the home care composition according to any foregoing embodiment, wherein the surfactant system comprises a nonionic surfactant selected from an alkyl polyglucoside, an alkoxylated alcohol, and a combination of two or more thereof.

In accordance with embodiment 14, provided is the home care composition according to embodiment 13, wherein the nonionic surfactant comprises an alkyl polyglucoside(s) selected from lauryl glucoside, octyl glucoside, decyl glucoside, coco glucoside, caprylyl/capryl glucoside, sodium lauryl glucose carboxylate, and a combination of two or more thereof.

In accordance with embodiment 15, provided is the home care composition according to embodiment 13 or embodiment 14, wherein the nonionic surfactant comprises an alkoxylated alcohol having about 1 to about 100 moles of an alkylene oxide per mole of alkoxylated alcohol.

In accordance with embodiment 16, provided is the home care composition according to any of embodiment 13 to embodiment 15, wherein the nonionic surfactant comprises an alkoxylated alcohol selected from ethoxylated octan-1-ol, ethoxylated C₉₋₁₁ alcohols, C₁₁₋₁₅ pareth, PPG C₁₂₋₁₄ pareth, and a combination of two or more thereof.

In accordance with embodiment 17, provided is the home care composition according to any foregoing embodiment, wherein the home care composition has a weight ratio of anionic surfactant to amphoteric surfactant of about 1:1 to about 7:1.

In accordance with embodiment 18, provided is the home care composition according to any foregoing embodiment, wherein the home care composition has a weight ratio of anionic surfactant to nonionic surfactant of about 1:1 to about 4:1.

In accordance with embodiment 19, provided is the home care composition according to any foregoing embodiment, wherein the home care composition comprises an emollient selected from flaxseed oil, lanolin oil, lanolin alcohol, ceramide, caprylic/capric triglyceride, and a combination of two or more thereof.

In accordance with embodiment 20, provided is the home care composition according to embodiment 19, wherein the emollient comprises flaxseed oil.

In accordance with an embodiment 21, provided is a home care composition comprising: an alginate; a cellulose; a polyol; and one or more surfactant comprising a betaine surfactant, an anionic surfactant, or a combination of two or more thereof, wherein the home care composition is in the form of a film.

In accordance with an embodiment 22, provided is a home care composition consisting of: one or more cellulose; one or more alginate; one or more polyol; one or more betaine surfactant; optionally one or more anionic surfactant; optionally one or more emollient; optionally, one or more fragrance; and optionally one or more preservative, wherein the home care composition is in the form of a film.

In accordance with an embodiment 23, provided is a home care composition comprising: a pullulan; a cellulose; a polyol; and one or more surfactant comprising a betaine surfactant, an anionic surfactant, or a combination of two or more thereof, wherein the home care composition is in the form of a film.

In accordance with an embodiment 24, provided is a home care composition consisting of: one or more cellulose; one or more pullulan; one or more polyol; one or more betaine surfactant; optionally one or more anionic surfactant; optionally one or more emollient; optionally, one or more fragrance; and optionally one or more preservative, wherein the home care composition is in the form of a film.

In accordance with an embodiment 25, provided is a pod comprising an outer film according to any foregoing embodiment.

### BRIEF DESCRIPTION OF THE DRAWINGS

The features, and advantages of the invention will be apparent from the following more detailed description of certain embodiments of the invention and as illustrated in the accompanying drawings in which:

FIG. 1 is a bar graph of the dissolvability of four non-limiting exemplary home care films in accordance with aspects of the invention;

FIG. 2 is a bar graph of the dissolvability of a non-limiting exemplary home care film and a comparative film in accordance with aspects of the invention;

FIG. 3 is a graph of the foam measurements of non-limiting exemplary home care films in accordance with aspects of the invention;

FIG. 4 is a graph of the grease emulsification of non-limiting exemplary home care films in accordance with aspects of the invention; and

FIG. 5 is a graph of the contact angle of a non-limiting exemplary home care film and a comparative film in accordance with aspects of the invention.

It should be understood that the various aspects are not limited to the compositions, arrangements, and instrumentality shown in the figures.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other compositions and methods. Before explaining the disclosed embodiments of the present invention in detail, it is to be understood that the invention is not limited in its application to the details of any particular embodiment disclosed herein. The terminology used herein is for the purpose of description and not of limitation.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but not limited to”.

As used throughout, ranges are used as shorthand for describing each and every value that is within the range. Any value within the range can be selected as the terminus of the range. Thus, a range from 1-5, includes specifically 1, 2, 3, 4 and 5, as well as subranges, such as 2-5, 3-5, 2-3, 2-4, 1-4, etc.

The term “about” when referring to a number means any number within a range of 10% of the number. For example, the phrase “about 2 wt. %” refers to a number between and including 1.8 wt. % and 2.2 wt. %.

All references cited herein are hereby incorporated by reference in their entireties. In the event of a conflict in a definition in the present disclosure and that of a cited reference, the present disclosure controls.

The abbreviations and symbols as used herein, unless indicated otherwise, take their ordinary meaning. The abbreviation “wt. %” means percent by weight with respect to the home care composition, unless indicated otherwise. The symbol “°” refers to a degree, such as a temperature degree or a degree of an angle. The symbols “h”, “min”, “mL”, “nm”, and “μm” refer to hour, minute, milliliter, nanometer, and micrometer, respectively. The abbreviation “UV-VIS” referring to a spectrometer or spectroscopy, means Ultraviolet-Visible. The abbreviation “rpm” means revolutions per minute.

When referring to chemical structures, and names, the symbols “C”, “H”, and “O” mean carbon, hydrogen, and oxygen, respectively. The symbols “—”, “═”, and “≡” mean single bond, double bond, and triple bond, respectively.

“Volatile”, as used herein, means having a flash point of less than about 100° C. “Non-volatile”, as used herein, means having a flash point of greater than about 100° C.

Any member in a list of species that are used to exemplify or define a genus, may be mutually different from, or overlapping with, or a subset of, or equivalent to, or nearly the same as, or identical to, any other member of the list of species. Further, unless explicitly stated, such as when reciting a Markush group, the list of species that define or exemplify the genus is open, and it is given that other species may exist that define or exemplify the genus just as well as, or better than, any other species listed.

The phrases, “a mixture thereof,” “a combination thereof,” or a combination of two or more thereof” do not require that the mixture include all of A, B, C, D, E, and F (although all of A, B, C, D, E, and F may be included). Rather, it indicates that a mixture of any two or more of A, B, C, D, E, and F can be included. In other words, it is equivalent to the phrase “one or more elements selected from the group consisting of A, B, C, D, E, F, and a mixture of any two or more of A, B, C, D, E, and F.” Likewise, the term “a salt thereof” also relates to “salts thereof.” Thus, where the disclosure refers to “an element selected from the group consisting of A, B, C, D, E, F, a salt thereof, and a mixture thereof,” it indicates that that one or more of A, B, C, D, and F may be included, one or more of a salt of A, a salt of B, a salt of C, a salt of D, a salt of E, and a salt of F may be included, or a mixture of any two of A, B, C, D, E, F, a salt of A, a salt of B, a salt of C, a salt of D, a salt of E, and a salt of F may be included.

All components and elements positively set forth in this disclosure can be negatively excluded from the claims. In other words, the home care compositions of the instant disclosure can be free or essentially free of all components and elements positively recited throughout the instant disclosure. In some instances, the home care compositions of the present disclosure may be substantially free of non-incidental amounts of the ingredient(s) or compound(s) described herein. A non-incidental amount of an ingredient or compound is the amount of that ingredient or compound that is added into the home care composition by itself. For example, an home care composition may be substantially free of a non-incidental amount of an ingredient or compound, although such ingredient(s) or compound(s) may be present as part of a raw material that is included as a blend of two or more compounds.

Some of the various categories of components identified may overlap. In such cases where overlap may exist and the home care composition includes both components (or the composition includes more than two components that overlap), an overlapping compound does not represent more than one component. For example, certain compounds may be characterized as both a polysaccharide and a film forming agent. If a particular home care composition includes both a polysaccharide and a film forming agent, hydroxyethyl cellulose will serve only as either the polysaccharide or the film forming agent—not both.

For readability purposes, the chemical functional groups are in their adjective form; for each of the adjectives, the word “group” is assumed. For example, the adjective “alkyl” without a noun thereafter, should be read as “an alkyl group.”

Aspects of the invention are directed to home care compositions and films formed therefrom. In accordance with an aspect of the invention, provided is a home care composition including a polysaccharide comprising a pullulan, an alginate, or a combination of two or more thereof; optionally, a cellulose; a polyol; and one or more surfactant comprising an anionic surfactant, a betaine surfactant, a nonionic surfactant, or a combination of two or more thereof, wherein the home care composition is in the form of a film. Without being limited to any particular theory, the films disclosed herein advantageously enable the delivery of certain ingredients (e.g., surfactants) while utilizing less water than comparative cleaning compositions, such as liquid soaps, liquid fabric cleaners, liquid dishwash compositions, or the like.

In accordance with another aspect of the invention, provided is a home care composition comprising an alginate; a cellulose; a polyol; and one or more surfactant comprising a betaine surfactant, an anionic surfactant, or a combination of two or more thereof, wherein the home care composition is in the form of a film.

In accordance with a further aspect of the invention, provided is a home care composition consisting of one or more cellulose; one or more alginate; one or more polyol; one or more betaine surfactant; optionally one or more anionic surfactant; and optionally one or more preservative, wherein the home care composition is in the form of a film.

In accordance with an additional aspect of the invention, provided is a home care composition including a pullulan; a cellulose; a polyol; and one or more surfactant comprising a betaine surfactant, an anionic surfactant, or a combination of two or more thereof, wherein the home care composition is in the form of a film.

In accordance with yet another aspect of the invention, provided is a home case composition consisting of one or more cellulose; one or more pullulan; one or more polyol; one or more betaine surfactant; optionally an anionic surfactant; and optionally one or more preservative, wherein the home care composition is in the form of a film.

In accordance with a further aspect of the invention, provided is a home case composition comprising one or more cellulose; one or more pullulan; one or more polyol; one or more betaine surfactant; one or more emollient (e.g., flaxseed); optionally an anionic surfactant; and optionally one or more preservative, wherein the home care composition is in the form of a film.

The home care compositions may be in the form of a film (sometimes referred herein as a home care film). The home care composition or home care film may be dissolved in water to obtain a diluted and/or ready-to-use cleaning solution. Suitable components, such as those listed below, may be included or excluded from the formulations for the home care compositions depending on the specific combination of other ingredients and the form of the home care compositions and/or the form.

The home care compositions typically comprise a polysaccharide comprising a pullulan, an alginate, or a combination of two or more thereof. In some embodiments, the polysaccharide consists of a pullulan, an alginate, and a combination of two or more thereof. For example, the home care compositions may comprise pullulan in an amount of about 3 to about 21 wt. %, about 3 to about 18 wt. %, about 3 to about 15 wt. %, about 3 to about 12 wt. %, about 3 to about 10 wt. %, about 3 to about 8 wt. %, about 3 to about 6 wt. %, about 3 to about 5 wt. %; from about 4 to about 21 wt. %, about 4 to about 18 wt. %, about 4 to about 15 wt. %, about 4 to about 12 wt. %, about 4 to about 10 wt. %, about 4 to about 8 wt. %, about 4 to about 6 wt. %, about 4 to about 5 wt. %; from about 5 to about 21 wt. %, about 5 to about 18 wt. %, about 5 to about 15 wt. %, about 5 to about 12 wt. %, about 5 to about 10 wt. %, about 5 to about 8 wt. %, about 5 to about 6 wt. %; from about 6 to about 21 wt. %, about 6 to about 18 wt. %, about 6 to about 15 wt. %, about 6 to about 12 wt. %, about 6 to about 10 wt. %, about 6 to about 8 wt. %; from about 8 to about 21 wt. %, about 8 to about 18 wt. %, about 8 to about 15 wt. %, about 8 to about 12 wt. %, about 8 to about 10 wt. %; from about 10 to about 21 wt. %, about 10 to about 18 wt. %, about 10 to about 15 wt. %, about 10 to about 12 wt. %; from about 12 to about 21 wt. %, about 12 to about 18 wt. %, about 12 to about 15 wt. %; from about 15 to about 21 wt. %, about 15 to about 18 wt. %, or about 18 to about 21 wt. %, or any range or subrange thereof, based on the total weight of the home care composition when in the form of a film.

Pullulan typically refers to a polysaccharide linear polymer consisting of maltotriose units. Three glucose units of maltotriose are connected by an α-1,4 glycosidic bond, whereas consecutive maltotriose units are connected to each other by an α-1,6 glycosidic bond. The pullulan may be obtained through a fermentation process from starch by the fungus Aurcobasidium pullulans.

The pullulan may have an average molecular weight of about 50 to 400 kDa, e.g., from about 100 to 400 kDa, about 150 to 300 kDa, about 180 and 250 kDa, or a range or subrange thereof. In at least one embodiment, the molecular weight is greater than about 50 kDa, greater than about 100 kDa, greater than about 150 kDa, or greater than about 200 kDa.

The home care composition may include an alginate in an amount ranging from about 3 to about 40 wt. %, based on the total weight of the home care composition when in the form of a film. In some embodiments, the alginate is present in the home care composition in an amount from about 3 to about 18 wt. %, about 3 to about 15 wt. %, about 3 to about 12 wt. %, about 3 to about 10 wt. %, about 3 to about 8 wt. %, about 3 to about 6 wt. %, about 3 to about 5 wt. %; from about 4 to about 21 wt. %, about 4 to about 18 wt. %, about 4 to about 15 wt. %, about 4 to about 12 wt. %, about 4 to about 10 wt. %, about 4 to about 8 wt. %, about 4 to about 6 wt. %, about 4 to about 5 wt. %; from about 5 to about 21 wt. %, about 5 to about 18 wt. %, about 5 to about 15 wt. %, about 5 to about 12 wt. %, about 5 to about 10 wt. %, about 5 to about 8 wt. %, about 5 to about 6 wt. %; from about 6 to about 21 wt. %, about 6 to about 18 wt. %, about 6 to about 15 wt. %, about 6 to about 12 wt. %, about 6 to about 10 wt. %, about 6 to about 8 wt. %; from about 8 to about 21 wt. %, about 8 to about 18 wt. %, about 8 to about 15 wt. %, about 8 to about 12 wt. %, about 8 to about 10 wt. %; from about 10 to about 21 wt. %, about 10 to about 18 wt. %, about 10 to about 15 wt. %, about 10 to about 12 wt. %; from about 12 to about 21 wt. %, about 12 to about 18 wt. %, about 12 to about 15 wt. %; from about 15 to about 21 wt. %, about 15 to about 18 wt. %, from about 20 to about 40 wt. %, about 20 to about 38 wt. %, about 20 to about 36 wt. %, about 20 to about 34 wt. %, about 20 to about 32 wt. %, about 20 to about 30 wt. %, about 20 to about 28 wt. %, about 20 to about 26 wt. %, about 20 to about 24 wt. %; from about 24 to about 40 wt. %, about 24 to about 38 wt. %, about 24 to about 36 wt. %, about 24 to about 34 wt. %, about 24 to about 32 wt. %, about 24 to about 30 wt. %, about 24 to about 28 wt. %; from about 28 to about 40 wt. %, about 28 to about 38 wt. %, about 28 to about 36 wt. %, about 28 to about 34 wt. %, about 28 to about 32 wt. %; from about 32 to about 40 wt. %, about 32 to about 38 wt. %, about 32 to about 36 wt. %; from about 36 to about 40 wt. %, about 36 to about 38 wt. %, or any range or subrange thereof, based on the total weight of the home care composition when in the form of a film.

The alginate can be selected from alginates obtained from Laminaria hyperborea, Macrocystis pyrifera, Laminaria digitata, Ascophyllum nodosum, and/or Laminaria japonica. The alginate may have a guluronic acid content (M/G ratio) of about 0.6 to about 3.2. The alginate may be in the form of a salt. Examples of alginates in the form of a salt include sodium alginate, calcium alginate, and potassium alginate. In some cases, the alginate is in the form of an ammonium alginate, an ester of alginic acid, and/or a propylene glycol alginate. The alginate may be selected from the group consisting of an ammonium alginate, an ester of alginic acid, s propylene glycol alginate, and a combination thereof.

The home care composition may also include one or more polysaccharides other than an alginate or a pullulan. For example, the home care composition may include a polysaccharide selected from chitosan, maltodextrin, pectin, xanthan gum, guar gum, gum arabic, algin, and a combination of two or more thereof. One or more of the foregoing polysaccharides other than an alginate or a pullulan may be excluded from certain embodiments of the home care composition.

The home care composition may include a cellulose in an amount that may vary, but typically is from about 3 to about 25 wt. %, based on the total weight of the home care composition when in the form of a film. In some embodiments, the cellulose is present in the home care composition in an amount from about 3 to about 21 wt. %, about 3 to about 18 wt. %, about 3 to about 15 wt. %, about 3 to about 12 wt. %, about 3 to about 10 wt. %, about 3 to about 8 wt. %, about 3 to about 6 wt. %, about 3 to about 5 wt. %; from about 4 to about 25 wt. %, about 4 to about 21 wt. %, about 4 to about 18 wt. %, about 4 to about 15 wt. %, about 4 to about 12 wt. %, about 4 to about 10 wt. %, about 4 to about 8 wt. %, about 4 to about 6 wt. %, about 4 to about 5 wt. %; from about 5 to about 25 wt. %, about 5 to about 21 wt. %, about 5 to about 18 wt. %, about 5 to about 15 wt. %, about 5 to about 12 wt. %, about 5 to about 10 wt. %, about 5 to about 8 wt. %, about 5 to about 6 wt. %; from about 6 to about 25 wt. %, about 6 to about 21 wt. %, about 6 to about 18 wt. %, about 6 to about 15 wt. %, about 6 to about 12 wt. %, about 6 to about 10 wt. %, about 6 to about 8 wt. %; from about 8 to about 25 wt. %, about 8 to about 21 wt. %, about 8 to about 18 wt. %, about 8 to about 15 wt. %, about 8 to about 12 wt. %, about 8 to about 10 wt. %; from about 10 to about 25 wt. %, about 10 to about 21 wt. %, about 10 to about 18 wt. %, about 10 to about 15 wt. %, about 10 to about 12 wt. %; from about 12 to about 25 wt. %, about 12 to about 21 wt. %, about 12 to about 18 wt. %, about 12 to about 15 wt. %; from about 15 to about 25 wt. %, about 15 to about 21 wt. %, about 15 to about 18 wt. %; from about 15 to about 25 wt. %, about 18 to about 21 wt. %, or any range or subrange thereof, based on the total weight of the home care composition when in the form of a film.

The cellulose is preferably a cellulose fiber. The cellulose may be selected from microcrystalline cellulose, hydroxypropylcellulose, hydroxypropylmethylcellulose, hydroxyethylcellulose, methylcellulose, carboxymethylcellulose, sodium carboxymethylcellulose, and a combination of two or more thereof. Further examples of cellulose include hydroxypropylmethylcellulose trimellitate, carboxymethylethylcellulose, cellulose acetate phthalate, cellulose triacetyl phthalate, sodium cellulose acetate phthalate, cellulose ester phthalate, cellulose ether phthalate, methylcellulose phthalate, cellulose ester-ether phthalate, hydroxy propyl cellulose phthalate, alkali salts of cellulose acetate phthalate, alkaline earth salts of cellulose acetate phthalate, calcium salt of cellulose acetate phthalate, ammonium salt of hydroxypropyl methylcellulose phthalate, cellulose acetate hexahydrophthalate, hydroxypropyl methylcellulose hexahydrophthalate, hydroxypropylmethcellulose phthalate, and a mixture of two or more thereof. In some embodiments, the cellulose may be oat fiber and/or sourced from oats.

The cellulose fiber may have a thickness and/or diameter ranging from about 1 micron to about 100 μm. In some instance, the cellulose fiber has a thickness and/or diameter from about 1 micron to about 100 μm, about 10 micron to about 100 μm, about 20 micron to about 100 μm, about 40 micron to about 100 μm, about 60 micron to about 100 μm, about 80 micron to about 100 μm; from about 1 micron to about 80 μm, about 10 micron to about 80 μm, about 20 micron to about 80 μm, about 40 micron to about 80 μm, about 60 micron to about 80 μm; from about 1 micron to about 60 μm, about 10 micron to about 60 μm, about 20 micron to about 60 μm, about 40 micron to about 60 μm; from about 1 micron to about 40 μm, about 10 micron to about 40 μm, about 20 micron to about 40 μm; from about 1 micron to about 20 μm, about 10 micron to about 20 μm, or any range or subrange thereof.

The home care composition typically includes a polyol, e.g., in an amount from about 1 to about 30 wt. %, based on the total weight of the home care composition when in the form of a film. In some embodiments, the amount of polyol(s) present in the home care composition is from about 1 to about 25 wt. %, about 1 to about 22 wt. %, about 1 to about 20 wt. %, about 1 to about 18 wt. %, about 1 to about 16 wt. %, about 1 to about 10 wt. %, about 1 to about 7 wt. %, about 1 to about 5 wt. %, about 1 to about 3 wt. %; from about 3 to about 30 wt. %, about 3 to about 25 wt. %, about 3 to about 22 wt. %, about 3 to about 20 wt. %, about 3 to about 18 wt. %, about 3 to about 16 wt. %, about 3 to about 10 wt. %, about 3 to about 7 wt. %, about 3 to about 5 wt. %; from about 5 to about 30 wt. %, about 5 to about 25 wt. %, about 5 to about 22 wt. %, about 5 to about 20 wt. %, about 5 to about 18 wt. %, about 5 to about 16 wt. %; from about 8 to about 30 wt. %, about 8 to about 25 wt. %, about 8 to about 22 wt. %, about 8 to about 20 wt. %, about 8 to about 18 wt. %, about 8 to about 16 wt. %; from about 10 to about 30 wt. %, about 10 to about 25 wt. %, about 10 to about 22 wt. %, about 10 to about 20 wt. %, about 10 to about 18 wt. %, about 10 to about 16 wt. %; from about 12 to about 30 wt. %, about 12 to about 25 wt. %, about 12 to about 22 wt. %, about 12 to about 20 wt. %, about 12 to about 18 wt. %, about 12 to about 16 wt. %; from about 14 to about 30 wt. %, about 14 to about 25 wt. %, about 14 to about 22 wt. %, about 14 to about 20 wt. %, about 14 to about 18 wt. %, about 14 to about 16 wt. %, including any range or subrange thereof, based on the total weight of the home care composition when in the form of a film.

The polyol(s) may be chosen from glycols or compounds with numerous hydroxyl groups. In some cases, the one or more polyols are selected from the group consisting of C₂-C₃₂ polyols. The one or more polyols may be liquid at ambient temperature (25° C.). The one or more polyols may have from 2 to 32 carbon atoms, from 3 to 16 carbon atoms, or from 3 to 12 carbon atoms.

Polyols that may be included in the home care composition, in certain instances, include ethylene glycol, propylene glycol, butylene glycol, hexylene glycol, glycerin, diglycerin, diethylene glycol, and dipropylene glycol, or a combination of two or more thereof. In some cases, the polyol is glycerin. Additional examples of polyols that may be incorporated in the home care composition include alkanediols, such as glycerin, 1,2,6-hexanetriol, trimethylolpropane, ethylene glycol, propylene glycol, butylene glycol, pentylene glycol, hexylene glycol, diethylene glycol, triethylene glycol, tetraethylene glycol, pentaethylene glycol, dipropylene glycol, 2-butene-1,4-diol, 2-ethyl-1,3-hexanediol, 2-methyl-2,4-pentanediol, caprylyl glycol, 1,2-hexanediol, 1,2-pentanediol, and 4-methyl-1,2-pentanediol; glycol ethers, such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, dipropylene glycol mono-iso-propyl ether; sorbitol; sorbitan; triacetin; and a mixture of two or more thereof. In some embodiments, the polyol is selected from ethylene glycol, propylene glycol, butylene glycol, hexylene glycol, pentylene glycol, 1,3-propanediol, diethylene glycol, dipropylene glycol, 1,4-butanediol, 1,5-pentanediol, hexane-1,6-diol, glycerin, diglycerin, caprylyl glycol, and a combination of two or more thereof.

The home care compositions may comprise one or more surfactant(s). The surfactant(s) may be present in the home care compositions in an amount from about 20 to about 70 wt. %, based on the total weight of the home care composition when in the form of a film. For instance, the home care composition may comprise a total amount of surfactant(s) of about 20 to about 65 wt. %, about 20 to about 60 wt. %, about 20 to about 57 wt. %, about 20 to about 54 wt. %, about 20 to about 51 wt. %, about 20 to about 47 wt. %; from about 25 to about 70 wt. %, about 25 to about 65 wt. %, about 25 to about 60 wt. %, about 25 to about 57 wt. %, about 25 to about 54 wt. %, about 25 to about 51 wt. %, about 25 to about 47 wt. %; from about 30 to about 70 wt. %, about 30 to about 65 wt. %, about 30 to about 60 wt. %, about 30 to about 57 wt. %, about 30 to about 54 wt. %, about 30 to about 51 wt. %, about 30 to about 47 wt. %; from about 35 to about 70 wt. %, about 35 to about 65 wt. %, about 35 to about 60 wt. %, about 35 to about 57 wt. %, about 35 to about 54 wt. %, about 35 to about 51 wt. %, about 35 to about 47 wt. %; from about 40 to about 70 wt. %, about 40 to about 65 wt. %, about 40 to about 60 wt. %, about 40 to about 57 wt. %, about 40 to about 54 wt. %, about 40 to about 51 wt. %, about 40 to about 47 wt. %; from about 42.5 to about 70 wt. %, about 42.5 to about 65 wt. %, about 42.5 to about 60 wt. %, about 42.5 to about 57 wt. %, about 42.5 to about 54 wt. %, about 42.5 to about 51 wt. %; from about 45 to about 70 wt. %, about 45 to about 65 wt. %, about 45 to about 60 wt. %, about 45 to about 57 wt. %, about 45 to about 54 wt. %, about 45 to about 51 wt. %; from about 47.5 to about 70 wt. %, about 47.5 to about 65 wt. %, about 47.5 to about 60 wt. %, about 47.5 to about 57 wt. %, about 47.5 to about 54 wt. %; from about 50 to about 70 wt. %, about 50 to about 65 wt. %, about 50 to about 60 wt. %, about 50 to about 57 wt. %, or any range or subrange thereof, based on the total weight of the home care composition when in the form of a film.

In some embodiments, however, the surfactant(s) may be present in a total amount from about 1 to about 15 wt. %, about 1 to about 12 wt. %, about 1 to about 9 wt. %, about 1 to about 7 wt. %, about 1 to about 5 wt. %, about 1 to about 4 wt. %, about 1 to about 3 wt. %, about 1 to about 2 wt. %; from about 2 to about 15 wt. %, about 2 to about 12 wt. %, about 2 to about 9 wt. %, about 2 to about 7 wt. %, about 2 to about 5 wt. %, about 2 to about 4 wt. %, about 2 to about 3 wt. %; from about 3 to about 15 wt. %, about 3 to about 9 wt. %, about 3 to about 7 wt. %, about 3 to about 5 wt. %, about 3 to about 4 wt. %; from about 5 to about 15 wt. %, about 5 to about 12 wt. %, about 5 to about 9 wt. %, about 5 to about 7 wt. %, or any range or subrange thereof, based on the total weight of the home care composition when in the form of a film.

The one or more surfactant(s) may comprise an anionic surfactant selected from sulfate anionic surfactants and/or salts thereof, including those selected from alkyl sulfates and alkyl ether sulfates. The alkyl sulfates and/or alkyl ether sulfates may have an alkyl group comprising from 8 to 20 carbon atoms, 8 to 16 carbon atoms, 10 to 16 carbon atoms, or 10 to 13 carbon atoms. Non-limiting examples of alkyl sulfate and alkyl ether sulfate salts include sodium lauryl sulfate (SLS), sodium dodecyl sulfate (SDS), sodium lauryl ether sulfate (SLES), ammonium lauryl sulfate, and ammonium laureth sulfate. In some embodiments, the sulfate anionic surfactants include sodium lauryl sulfate, sodium laureth sulfate, a salt thereof, or a combination of two or more thereof. The anionic surfactant may comprise non-sulfate surfactants, such as Olefin Sulfonate C16. In at least one embodiment, the one or more surfactants comprises a reaction product of hexadecene with sulfur trioxide, hydrolyzed, potassium salts. In further embodiments, the one or more surfactants may be selected from rhamnolipids, sophorolipds, or a combination thereof. The sophorolipds may be fermentation products of glucose and fatty acids, C18-unsatd., esters with glycerol with yeast Candida bombicola, partially hydrolysed.

Additionally or alternatively, the home care composition may include an amphoteric surfactant. The amphoteric surfactant(s) may be selected from betaine surfactants (also referred to as betaines). Examples of amphoteric surfactants include, but are not limited to, a range of betaines including, for example, high alkyl betaines, such as coco dimethyl carboxymethyl betaine, lauryl dimethyl carboxy-methyl betaine, lauryl dimethyl alpha-carboxyethyl betaine, cetyl dimethyl carboxymethyl betaine, lauryl bis-(2-hydroxyethyl) carboxy methyl betaine, stearyl bis-(2-hydroxypropyl) carboxymethyl betaine, oleyl dimethyl gamma-carboxypropyl betaine, and lauryl bis-(2-hydroxypropyl) alpha-carboxyethyl betaine, sulfobetaines such as coco dimethyl sulfopropyl betaine, stearyl dimethyl sulfopropyl betaine, amido betaines, amidosulfobetaines, and mixtures thereof.

Preferably, a betaine surfactant is selected from coca betaine, cocamidopropyl betaine, lauryl betaine, laurylhydroxy sulfobetaine, lauryldimethyl betaine, cocamidopropyl hydroxysultaine, behenyl betaine, capryl/capramidopropyl betaine, lauryl hydroxysultaine, stearyl betaine, and combinations of two or more thereof. In some embodiments, at least one betaine surfactant is selected from coco betaine, cocamidopropyl betaine, behenyl betaine, capryl/capramidopropyl betaine, lauryl betaine, and a combination of two or more thereof. In some instances, the betaine surfactant is, preferably, selected from coca betaine, cocamidopropyl betaine, lauryl betaine, laurylhydroxy sulfobetaine, lauryldimethyl betaine, cocamidopropyl hydroxysultaine, behenyl betaine, capryl/capramidopropyl betaine, lauryl hydroxysultaine, stearyl betaine, and a combination of two or more thereof. In at least one embodiment, the home care composition comprises coco betaine, cocamidopropyl betaine, or a combination thereof.

The amphoteric surfactant may, in some cases, be selected sultaines, also known as sulfobetaines, and hydroxy sultaines, e.g., cocamidopropyl hydroxysultain. The sultaines may be an alkyl sultaines having from 6 to 20 carbons, 8 to 18 carbons, 8 to 16 carbons, or 10 to 16 carbons. Examples of alkyl sultaine surfactants include, but are not limited to, cocamidopropyl hydroxysultaine, lauryl hydroxysultaine, and a combination of two or more thereof.

In some embodiments, the surfactant(s) includes an amphoteric surfactant selected from betaine surfactants and an anionic surfactant, such as a sulfate based surfactant discussed above.

The home care compositions may, in some preferred embodiments, have a weight ratio of the total amount of the anionic surfactant(s) to the total amount of amphoteric surfactant(s) of about 1:1 to about 7:1. For example, the weight ratio of the anionic surfactant to the amphoteric surfactant may be from about 1:1 to about 6:1, about 1:1 to about 5:1, about 1:1 to about 4:1, about 1:1 to about 3:1; from about 2:1 to about 7:1, about 2:1 to about 6:1, about 2:1 to about 5:1, about 2:1 to about 4:1, about 2:1 to about 3:1; from about 3:1 to about 7:1, about 3:1 to about 6:1, about 3:1 to about 5:1, about 3:1 to about 4:1; from about 4:1 to about 7:1, about 4:1 to about 6:1, about 4:1 to about 5:1; from about 5:1 to about 7:1, about 5:1 to about 6:1, or any range or subrange thereof.

The one or more surfactants may, additionally or alternatively, include a nonionic surfactant. The nonionic surfactant may be selected from alkyl polyglucosides, alkylamides, alkanolamides, polyoxyalkylenated nonionic surfactants, polyglycerolated nonionic surfactants, ethoxylated fatty esters (such as, polyglyceryl-2-caprate), and a combination of two or more thereof. In some cases, the nonionic surfactant may be selected from alkyl polyglucosides, alkylamides, and/or alkanolamides and may have an alkyl group having 8 to 32 carbons, 8 to 26 carbons, 8 to 22 carbons, 8 to 18 carbons, 10 to 22 carbons, 10 to 18 carbons, 12 to 22 carbons, or 12 to 18 carbons. In at least one preferred embodiment, the nonionic surfactant comprises an alkyl polyglucoside, an alkylamide, an alkanolamide, or a combination of two or more thereof having an alkyl group of 12 to 18 carbons.

The nonionic surfactant may be selected from alkyl polyglucosides in some cases. In some instances, the alkyl polyglucoside(s) are chosen from lauryl glucoside, octyl glucoside, decyl glucoside, coco glucoside, caprylyl/capryl glucoside, sodium lauryl glucose carboxylate, and a combination of two or more thereof. In at least one embodiment, the home care composition includes one or more nonionic surfactant comprising caprylyl glucoside and/or caprylyl/capryl glucoside. Non-limiting examples of nonionic surfactants worth mentioning include esters of polyols with fatty acids having a saturated or unsaturated chain, e.g., containing from 8 to 24 carbon atoms or 12 to 22 carbon atoms, and/or alkoxylated derivatives thereof. For example, the home care composition may comprise polyethylene glycol esters of a C₈-C₂₄, such as C₁₂-C₂₂ glycol esters; sorbitol esters of a C₈-C₂₄, such as C₁₂-C₂₂ sorbitol esters; sugar (sucrose, glucose, alkylglycose) esters of a C₈-C₂₄; ethers of sugar and a C₈-C₂₄; or combinations of two or more thereof.

The nonionic surfactant may be selected from alkoxylated alcohols, e.g., having about 1 to about 100 moles of an alkylene oxide per mole of alkoxylated alcohol. As examples of alkoxylated fatty alcohols, steareth (for example, steareth-2, steareth-20, and steareth-21), laureth (for example, laureth-4, and laureth-12), ceteth (for example, ceteth-10 and ceteth-20) and ceteareth (for example, ceteareth-2, ceteareth-10, and ceteareth-20) are worth mentioning. In at least one instance, the one or more alkoxylated fatty alcohols include steareth-20. In some instances, the one or more alkoxylated fatty alcohols may be exclusively steareth-20. The alkylated fatty alcohols may include ethoxylated octan-1-ol, C₁₁₋₁₅ pareth, PPG C₁₂₋₁₄ pareth, or a combination of two or more thereof.

In some instances, the nonionic surfactant may comprise a fatty alcohol derivative, such as methyl stearyl ether; 2-ethylhexyl dodecyl ether; stearyl acetate; cetyl propionate; the ceteth series of compounds, such as ceteth-1 through ceteth-45, which are ethylene glycol ethers of cetyl alcohol, wherein the numeric designation indicates the number of ethylene glycol moieties present; the steareth series of compounds such as steareth-1 through 10, which are ethylene glycol ethers of steareth alcohol, wherein the numeric designation indicates the number of ethylene glycol moieties present; ceteareth 1 through ceteareth-10, which are the ethylene glycol ethers of ceteareth alcohol, i.e., a mixture of fatty alcohols containing predominantly cetyl and stearyl alcohol, wherein the numeric designation indicates the number of ethylene glycol moieties present; C₁-C₃₀ alkyl ethers of the ceteth, steareth, and ceteareth compounds described above; polyoxyethylene ethers of branched alcohols, such as octyldodecyl alcohol, dodecylpentadecyl alcohol, hexyldecyl alcohol, and isostearyl alcohol; polyoxyethylene ethers of behenyl alcohol; PPG ethers, such as PPG-9-steareth-3, PPG-11 stearyl ether, PPG8-ceteth-1, and PPG-10 cetyl ether; and a combination of two or more thereof.

The nonionic surfactants may be selected from ethoxylated fatty esters, such as adducts of ethylene oxide with esters of lauric acid, palmitic acid, stearic acid, behenic acid, and mixtures thereof, including those containing from 9 to 100 oxyethylene groups. In some cases, the ethoxylated fatty esters may comprise PEG-9 laurate to PEG-50 laurate; PEG-9 palmitate to PEG-50 palmitate; PEG-9 stearate to PEG-50 stearate; PEG-9 palmitostearate to PEG-50 palmitostearate; PEG-9 behenate to PEG-50 behenate; polyethylene glycol 100 EO monostearate (such as, PEG-100 stearate); or combinations of two or more thereof. As examples of glyceryl esters of fatty acids, glyceryl stearate (glyceryl mono-, di- and/or tristearate), glyceryl ricinoleate, and a combination of two or more thereof may be incorporated in the home care composition. Examples of glyceryl esters of C₈-C₂₄ alkoxylated fatty acids include polyethoxylated glyceryl stearate (glyceryl mono-, di- and/or tristearate), such as PEG-20 glyceryl stearate.

The home care composition may, in some preferred embodiments, have a weight ratio of the total amount of the anionic surfactant(s) to the total amount of the nonionic surfactant(s) of about 1:1 to about 4:1. For instance, the weight ratio of the anionic surfactant(s) to the nonionic surfactant(s) may be from about 1:1 to about 4:1, about 1:1 to about 3:1, about 1:1 to about 2:1; from about 2:1 to about 4:1, about 2:1 to about 3:1; from about 3:1 to about 4:1, or any range or subrange thereof.

Additionally and/or alternatively, the home care composition may include one or more film forming agent(s) other than cellulose or polysaccharides. The total amount of film forming agent(s) other than celluloses or polysaccharides may be from about 1 to about 10 wt. %, about 1 to about 8 wt. %, about 1 to about 6 wt. %, about 1 to about 4 wt. %, about 1 to about 3 wt. %; from about 3 to about 10 wt. %, about 3 to about 8 wt. %, about 3 to about 6 wt. %, about 3 to about 5 wt. %; from about 5 to about 10 wt. %, about 5 to about 8 wt. %, about 5 to about 7 wt. %; from about 7 to about 10 wt. %, about 7 to about 9 wt. %, or any range or subrange thereof, based on the total weight of the home care composition when in the form of a film.

The film forming agent(s) may be selected from water-soluble, water-dispersible, water-swellable, water-insoluble, or combinations thereof. As examples of various potentially suitable film forming agents, polyvinyl compounds, styrol-butadiene-acrylate copolymers, polyacrylates, and polyamides are worth mentioning. For instance, the home care composition may comprise a polyvinyl pyrrolidone, a polyvinyl alcohol, a polyethylene glycol, a polyethylene oxide, polyacrylic acid, a methylmethacrylate copolymer, a carboxyvinyl copolymers, various copolymer or combinations thereof, or a combination of two or more thereof.

The home care composition may include one or more plasticizer(s), e.g., in an amount from about 1 to about 10 wt. %, based on the total weight of the home care composition when in the form of a film. For example, the home care composition have a total amount of plasticizer(s) from about 1 to about 10 wt. %, about 1 to about 8 wt. %, about 1 to about 6 wt. %, about 1 to about 4 wt. %, about 1 to about 3 wt. %; from about 3 to about 10 wt. %, about 3 to about 8 wt. %, about 3 to about 6 wt. %, about 3 to about 5 wt. %; from about 5 to about 10 wt. %, about 5 to about 8 wt. %, about 5 to about 7 wt. %; from about 7 to about 10 wt. %, about 7 to about 9 wt. %, or any range or subrange thereof, based on the total weight of the home care composition when in the form of a film.

The plasticizer may modify a property of the film or for use as e.g., a further solvent, a dispersant, or as another film-forming polymer. Non-limiting examples of plasticizers include polyethylene glycol (PEG), polypropylene glycol (PPG), block polymers of polyethylene glycol and polypropylene glycol, phthalic esters, phosphoric esters, esters of adipic, azelaic, glutamic or sebacic acid, fatty acid esters citric esters, esters of acetic, propionic or butyric acid, esters of ethylbutyric or ethyl hexanoic acid, glycol esters, benzoic esters, trimellitic esters, sulfonic esters, sulfonamides, anilides, alcohols, ethers, ketones, or a combination of two or more thereof. Examples of citric acid esters include acetyl tributyl citrate and acetyl triethyl citrate.

The plasticizers may be selected from a polyethylene glycol, a polypropylene glycol, or a block polymer of polyethylene glycol and polypropylene glycol (PEG/PPG block copolymer) having a molecular weight of from about 100 to 5000 g/mol. In some embodiments, the plasticizer comprises a polypropylene glycol, a polypropylene glycol, and/or a PEG/PPG block copolymer having a molecular weight of about 100 to about 900, about 200 to about 800, about 400, about 1500 to about 2500, about 2000 to about 4500 or any range or subrange thereof. In some embodiments, the polyol is a polyethylene glycol, such as polyethylene glycol 600. In some embodiments, the home care compositions may comprise one or more polyethylene glycols, e.g., polyethylene glycols in a molecular weight range from 200 to 800. For example, the home care compositions may comprise one or more of polyethylene glycol 200, polyethylene glycol 300, polyethylene glycol 400, polyethylene glycol 600, or polyethylene glycol 800.

The home care compositions may comprise one or more emollients. The amount of emollient(s) in the home care composition may be from about 1 to about 30 wt. %, based on the total weight of the home care composition when in the form of a film. For example, the total amount of the emollient(s) in the home care composition may be from about 1 to about 25 wt. %, about 1 to about 22 wt. %, about 1 to about 20 wt. %, about 1 to about 18 wt. %, about 1 to about 16 wt. %, about 1 to about 10 wt. %, about 1 to about 7 wt. %, about 1 to about 5 wt. %, about 1 to about 3 wt. %; from about 3 to about 30 wt. %, about 3 to about 25 wt. %, about 3 to about 22 wt. %, about 3 to about 20 wt. %, about 3 to about 18 wt. %, about 3 to about 16 wt. %, about 3 to about 10 wt. %, about 3 to about 7 wt. %, about 3 to about 5 wt. %; from about 5 to about 30 wt. %, about 5 to about 25 wt. %, about 5 to about 22 wt. %, about 5 to about 20 wt. %, about 5 to about 18 wt. %, about 5 to about 16 wt. %; from about 8 to about 30 wt. %, about 8 to about 25 wt. %, about 8 to about 22 wt. %, about 8 to about 20 wt. %, about 8 to about 18 wt. %, about 8 to about 16 wt. %; from about 10 to about 30 wt. %, about 10 to about 25 wt. %, about 10 to about 22 wt. %, about 10 to about 20 wt. %, about 10 to about 18 wt. %, about 10 to about 16 wt. %; from about 12 to about 30 wt. %, about 12 to about 25 wt. %, about 12 to about 22 wt. %, about 12 to about 20 wt. %, about 12 to about 18 wt. %, about 12 to about 16 wt. %; from about 14 to about 30 wt. %, about 14 to about 25 wt. %, about 14 to about 22 wt. %, about 14 to about 20 wt. %, about 14 to about 18 wt. %, about 14 to about 16 wt. %, including any range or subrange thereof, based on the total weight of the home care composition when in the form of a film.

The one or more emollient(s) may be selected from Bis-PEG-18 methyl ether dimethyl silane, squalane, PEG 3350, phospholipids, sodium hyaluronate, behenyl alcohol, Butyrospermum Parkii (Shea Butter), Cyclomethicone, Lactobacillus/Eriodictyon californicum Ferment Extract and the like, Methyl Gluceth-20, Prunus amygdalus dulcis (Sweet Almond) Oil, Sodium Lactate, Borago officinalis (Borage) Seed Oil, Persea Gratissima (Avocado) Oil, Vitamin D and its derivatives, caprylic/capric triglyceride, lanolin oil, lanolin alcohol, ceramide, trehalose, mannan, flaxseed oil, and a combination of two or more thereof. For example, the one or more emollients may comprise flaxseed oil, lanolin oil, lanolin alcohol, ceramide, caprylic/capric triglyceride, or a combination of two or more thereof.

The amount of the pH adjuster in the home care composition may be based on the desired pH of the final form of home care composition (e.g., a cleaning solution obtained by dissolving the home care composition film in a water or an aqueous solution). For instance, the total amount of the pH adjuster may range from about 0.05 to about 20 wt. %, based on the total weight of the home care composition. In some instances, the total amount of pH adjuster is from about 0.05 to about 15 wt. %, about 0.1 to about 10 wt. %, or about 0.12 to about 5 wt. %, including ranges and sub-ranges thereof, based on the total weight of the home care composition.

The home care compositions may have a pH of 4 to 11. For instance, the home care composition may be in the form of a pre-film solution having a pH of 6 to 11 or, e.g., from about 6 to about 10, about 6 to about 9, about 6 to about 8, or about 6 to about 7; from about 7 to about 10, about 7 to about 9, or about 7 to about 8; from about 8 to about 10, about 8 to about 9, about 9 to about 11, or any range or subrange thereof. Additionally or alternatively, the home care compositions may be in the form of a film that when dissolved in water has a pH of about 4 to 10 or, e.g., about 4.5 to about 10, about 4.5 to about 9, about 4.5 to about 8, about 4.5 to about 7, about 4.5 to about 6; from about 5 to about 10, about 5 to about 9, about 5 to about 8, about 5 to about 7, about 5 to about 6, or any range or subrange thereof.

The home care compositions may, in some cases, comprise one or more preservatives. The home care composition may be formulated to have preservative(s) in an amount from about 0.1 to about 12 wt. %, based on the total weight of the home care composition when in the form of a film. For example, the preservative(s) may be present in the home care composition in an amount from about 0.1 to about 12 wt. %, about 0.1 to about 10 wt. %, about 0.1 to about 8 wt. %, about 0.1 to about 6 wt. %, about 0.1 to about 4 wt. %, about 0.1 to about 3 wt. %, about 0.1 to about 2 wt. %, about 0.1 to about 1 wt. %; from about 1 to about 12 wt. %, about 1 to about 10 wt. %, about 1 to about 8 wt. %, about 1 to about 6 wt. %, about 1 to about 4 wt. %, about 1 to about 3 wt. %; from about 2 to about 12 wt. %, about 2 to about 10 wt. %, about 2 to about 8 wt. %, about 2 to about 6 wt. %, about 2 to about 4 wt. %, about 2 to about 3 wt. %; from about 3 to about 12 wt. %, about 3 to about 10 wt. %, about 3 to about 8 wt. %, about 3 to about 6 wt. %, about 3 to about 4 wt. %; from about 5 to about 12 wt. %, about 5 to about 10 wt. %, about 5 to about 8 wt. %, or any range or subrange thereof, based on the total weight of the home care composition when in the form of a film.

The one or more preservatives may include at least one of lactic acid, benzalkonium chloride, sodium benzoate, potassium sorbate, hydroxyacetophenone, ethylhexylglycerin, or a combination of thereof. Additional examples of preservatives that may incorporated in the preservative system include, but are not limited to, 4-hydroxy benzoic acid, benzoic acid, sorbic acid, dehydroacetic acid, triclosan, benzyl alcohol, chlorophenesin, salicylic acid, hydroxy acetophenone, caprylhydroxamic acid, phenethyl alcohol, p-anisic acid, glyceryl caprylate, levulinic acid, sodium levulinate, propanediol, hexanediol, pentylene glycol, capryloyl glycine, methylpropanediol, phenylpropanol, sodium anisate, or a combination of two or more thereof.

The preservative system may, in some cases, include or exclude one or more of the following preservatives: chlorhexidine, chlorhexidine digluconate, chlorhexidine dihydrochloride, chlorhexidine diacetate, chlorhexidine gluconate, chlorhexidine hydrochloride, chlorhexidine phosphanilate, chlorphensin, benzoic acid or a salt or ester thereof (e.g. sodium benzoate), propionic acid or a salt thereof, salicylic acid or a salt thereof, sorbic acid or a salt thereof (e.g. potassium sorbate), formaldehyde, paraformaldehyde, zinc pyrithione, inorganic sulphites, hydrogen sulphites, chlorobutanol, 4-hydroxybenzoic acid or a salt or ester thereof (e.g. methylparaben, ethylparaben, propylparaben), dehydroacetic acid and/or a salt thereof (e.g. sodium dehydroacetate), formic acid or a salt thereof, dibromohexamidine isethionate; thimerosal, phenylmecuric salts, undecylenic acid or a salt thereof, hexetidine, bronopol, 5-bromo-5-nitro-1,3-dioxane, dichlorobenzyl alcohol, benzyl alcohol, triclocarban, chlororesol, triclosan, chloroxylenol, imidazolidinyl urea, polyaminopropyl biguanide, phenoxyethanol, methenamine, quaternium-15, climbazole, DMDM hydantoin, 1-hydroxy-4-methyl-6-(2,4,4-trimethylenepentyl)-2 pyridon, piroctone olamine, bromochlorophene, 0-cymen-5-ol, methylchloroisothiazolinone, methylisothiazololinone, mixtures of methylchloroisothiazolinone and methylisothiazololinone, chlorophene, chloroacetamide, phenoxyisoproponol, alkyl (C12-C22) trimethyl ammonium bromide, alkyl (C12-C22) trimethyl ammonium chloride, dimethyl oxazolidine, diazolidinyl urea, hexamidine, hexamidine diisethionate, hexamidine diparaben, hexamidine paraben, glutaral, 7-ethylbicyclooxazolidine, sodium hydroxymethylaminoacetate, silver chloride, benzethonium chloride, benzalkonium chloride, benzalkonium bromide, benzalkonium saccharinate, benzylhemiformal, iodopropynyl butylcarbamate, silver citrate, or a combination of two or more thereof.

The home care composition may include one or more fragrances. The amount of fragrances present in the home care composition may be from about 0.01 to about 4 wt. %, about 0.01 to about 3 wt. %, about 0.01 to about 2 wt. %, about 0.01 to about 1 wt. %, about 0.01 to about 0.5 wt. %, about 0.01 to about 0.1 wt. %; about 0.1 to about 5 wt. %, about 0.1 to about 4 wt. %, about 0.1 to about 3 wt. %, about 0.1 to about 2 wt. %, about 0.1 to about 1 wt. %, about 0.1 to about 0.5 wt. %, about 0.1 to about 0.1 wt. %; about 0.5 to about 5 wt. %, about 0.5 to about 4 wt. %, about 0.5 to about 3 wt. %, about 0.5 to about 2 wt. %, about 0.5 to about 1 wt. %; about 0.75 to about 5 wt. %, about 0.75 to about 4 wt. %, about 0.75 to about 3 wt. %, about 0.75 to about 2 wt. %, about 0.75 to about 1 wt. %; about 1 to about 5 wt. %, about 1 to about 4 wt. %, about 1 to about 3 wt. %, about 1 to about 2 wt. %; about 2 to about 5 wt. %, about 2 to about 4 wt. %, about 2 to about 3 wt. %; about 3 to about 5 wt. %, about 3 to about 4 wt. %, including any range or subrange therebetween, based on the total weight of the home care composition when in the form of a film.

Non-limiting examples of fragrances and perfumes include odor compounds selected from: 7-acetyl-1,2,3,4,5,6,7,8-octahydro-1,1,6,7-tetramethylnaphthalene, α-ionone, β-ionone, γ-ionone α-isomethylionone, methylcedrylone, methyl dihydrojasmonate, methyl 1,6,10-trimethyl-2,5,9-cyclododecatrien-1-yl ketone, 7-acetyl-1,1,3,4,4,6-hexamethyltetralin, 4-acetyl-6-tert-butyl-1,1-dimethylindane, hydroxyphenylbutanone, benzophenone, methyl β-naphthyl ketone, 6-acetyl-1,1,2,3,3,5-hexamethylindane, 5-acetyl-3-isopropyl-1,1,2,6-tetramethylindane, 1-dodecanal, 4-(4-hydroxy-4-methylpentyl)-3-cyclohexene-1-carboxaldehyde, 7-hydroxy-3,7-dimethyloctanal, 10-undecen-1-al, isohexenylcyclohexylcarboxaldehyde, formyltricyclodecane, condensation products of hydroxycitronellal and methyl anthranilate, condensation products of hydroxycitronellal and indole, condensation products of phenylacetaldehyde and indole, 2-methyl-3-(para-tert-butylphenyl) propionaldehyde, ethylvanillin, heliotropin, hexylcinnamaldehyde, amylcinnamaldehyde, 2-methyl-2-(isopropylphenyl) propionaldehyde, coumarin, γ-decalactone, cyclopentadecanolide, 16-hydroxy-9-hexadecenoic acid lactone, 1,3,4,6,7,8-hexahydro-4,6,6,7,8,8-hexamethylcyclopenta-γ-2-benzopyran, β-naphthol methyl ether, ambroxane, dodecahydro-3a,6,6,9a-tetramethylnaphtho [2,1b]furan, cedrol, 5-(2,2,3-trimethylcyclopent-3-enyl)-3-methylpentan-2-ol, 2-ethyl-4-(2,2,3-trimethyl-3-cyclopenten-1-yl)-2-buten-1-ol, caryophyllene alcohol, tricyclodecenyl propionate, tricyclodecenyl acetate, benzyl salicylate, cedryl acetate, and tert-butylcyclohexyl acetate.

Other fragrances may include odor compounds selected from essential oils, resinoids and resins from a large number of sources, such as, for example, Peru balsam, olibanum resinoid, styrax, labdanum resin, nutmeg, cassia oil, benzoin resin, coriander, and lavandin.

Further examples of fragrances include odor compounds selected from phenylethyl alcohol, terpineol, linalool, linalyl acetate, geraniol, nerol, 2-(1,1-dimethylethyl)cyclo-hexanol acetate, benzyl acetate, and eugenol. The fragrances or perfumes can be used as single substances or in a mixture with one another.

The home care composition may, in some instances, include water when in the form of a film. For example, the amount of water present in the home care composition may be from about 0.5 to about 17 wt. %, about 0.5 to about 14 wt. %, about 0.5 to about 11 wt. %, about 0.5 to about 8 wt. %, about 0.5 to about 6 wt. %, about 0.5 to about 4 wt. %, about 0.5 to about 2 wt. %; from about 1 to about 20 wt. %, about 1 to about 17 wt. %, about 1 to about 14 wt. %, about 1 to about 11 wt. %, about 1 to about 8 wt. %, about 1 to about 6 wt. %, about 1 to about 4 wt. %, about 1 to about 3 wt. %; from about 2 to about 20 wt. %, about 2 to about 17 wt. %, about 2 to about 14 wt. %, about 2 to about 11 wt. %, about 2 to about 8 wt. %, about 2 to about 6 wt. %; from about 4 to about 20 wt. %, about 4 to about 17 wt. %, about 4 to about 14 wt. %, about 4 to about 11 wt. %, about 4 to about 8 wt. %; from about 6 to about 20 wt. %, about 6 to about 17 wt. %, about 6 to about 14 wt. %, about 6 to about 11 wt. %, about 6 to about 8 wt. %; from about 8 to about 20 wt. %, about 8 to about 17 wt. %, about 8 to about 14 wt. %, about 8 to about 11 wt. %; from about 10 to about 20 wt. %, about 10 to about 17 wt. %, about 10 to about 14 wt. %; from about 12 to about 20 wt. %, about 12 to about 17 wt. %, about 12 to about 14 wt. %; from about 15 to about 20 wt. %, about 15 to about 18 wt. %, or any range or subrange thereof, based on the total weight of the home care composition when in the form of a film.

As mentioned above, the home care composition may be dissolved in water or an aqueous solution to form a diluted cleaning solution. The diluted cleaning solution may be in a ready-to-use form. For example, the diluted cleaning solution may be formed by dissolving a home care film or pod in water or an aqueous solution. In some embodiments, the home care composition and/or home care film may be dissolved in water at a weight ratio of about 1:0.5 to about 1:30 to produce a diluted cleaning solution. For instance, the home care composition and/or home care film may be dissolved in water at a weight ratio (home care composition:water) of about 1:0.5 to about 1:10, about 1:0.5 to about 1:8, about 1:0.5 to about 1:6, about 1:0.5 to about 1:4, about 1:0.5 to about 1:2, about 1:0.5 to about 1:1; from about 1:1 to about 1:10, about 1:1 to about 1:8, about 1:1 to about 1:6, about 1:1 to about 1:4, about 1:1 to about 1:2; from about 1:2 to about 1:10, about 1:2 to about 1:8, about 1:2 to about 1:6, about 1:2 to about 1:4; from about 1:3 to about 1:10, about 1:3 to about 1:8, about 1:3 to about 1:6, about 1:3 to about 1:4; from about 1:4 to about 1:10, about 1:4 to about 1:8, about 1:4 to about 1:6; from about 1:8 to about 1:30, about 1:8 to about 1:25, about 1:8 to about 1:20, about 1:8 to about 1:16, about 1:8 to about 1:12; from about 1:14 to about 1:30, about 1:14 to about 1:25, about 1:14 to about 1:20; from about 1:20 to about 1:30, about 1:20 to about 1:25, about 1:25 to about 1:30, or any range or subrange thereof.

In accordance with further aspects of the invention, provided is a pod formed from any of the home care compositions in the form of a film disclosed herein.

### EXAMPLES

### Example 1

Four example home care compositions (Example Films A-D) were prepared in the form of a film according to aspects of the invention. The formulation for Example Films A-D are provided in Table 1.

TABLE 1

| Example Film A | Example Film B | Example Film C | Example Film D |
|---|---|---|---|
| 25 wt. % of | 17 wt. % APG | 10 wt. % of | 7 wt. % of |
| SLES/LMDO | | SLES/CAPB | SLES/LBet |
| in a | | in a ratio | in a |
| ratio of 3.5:1 | | of 3.5:1 | ratio of 3.5:1 |
| Sodium Alginate | Sodium Alginate | Sodium Alginate | Sodium |
| | | | Alginate |
| Glycerin | Glycerin | Glycerin | Glycerin |
| Cellulose | Gum Arabic | Cellulose | Cellulose |
| pH = 7.2 | pH = 7.2 | pH = 3.5 | pH = 3.5 |

### Example 2

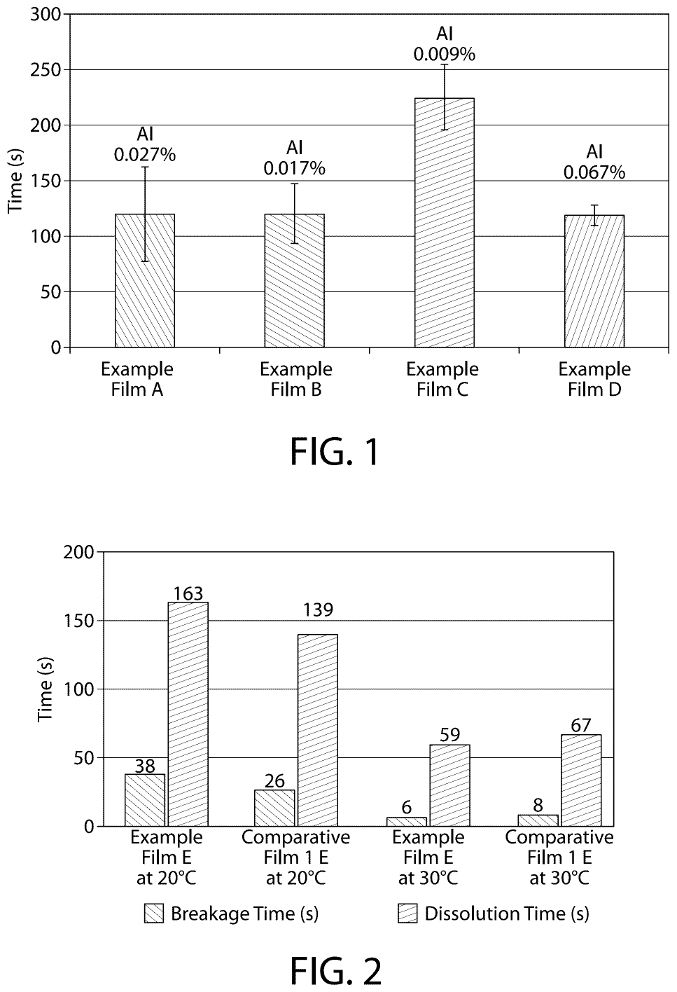

Example Films A-D were evaluated to assess their dissolvability. Samples of Example Films A-D were dissolved in 200 mL of distilled water at a temperature of 25° C. while being stirred at 260 rpms with a magnetic stirrer over a hot plate. A summary of the results of the dissolvability evaluation of Examples Films A-D is shown in FIG. 1.

### Example 3

An example home care composition (Example Film E) and a comparative composition (Comparative Film 1) were prepared in the form of films having a thickness of 89 micrometers and 76 micrometers, respectively. Example Film E had the following ingredients pullulan, glycerin, oat fiber, water (as moisture), polysorbate 80, and dextrose. Comparative Film 1 was a commercial PVA film.

### Example 4

Example Film E and Comparative Film 1 were used to prepare pods, which were evaluated to assess the dissolvability of Example Film E and Comparative Film 1. The pods contained a powdered composition comprising sodium bicarbonate, citric acid, sodium chloride, sodium lauryl sulfate, C₉₋₁₁ alcohol, fragrance, and color. Solubility was evaluated at two stages, namely, at the time when the pods broke without agitation and the powder composition began to leak into solution and at the time when the film of the pod was fully dissolved with agitation at 260 rpm. Two temperature conditions were evaluated, 20° C. and 30° C. A summary of the results of the dissolvability evaluation of Example Film E and Comparative Film 1 are shown in FIG. 2.

### Example 5

Five example home care compositions (Example Films F-J) were prepared in the form of films. The formulations for Example Films F-J are shown in Table 3.

TABLE 3

| | Example | Example | Example | Example | Example |
|---|---|---|---|---|---|
| | Film F | Film G | Film H | Film I | Film J |
| | (wt. %) | (wt. %) | (wt. %) | (wt. %) | (wt. %) |
| Sodium Lauryl | 43 | 43 | 42.1 | 42.1 | 42.1 |
| Ether Sulfate | | | | | |
| Laurylamidopropyl | 12 | 12 | 12 | 11.9 | 11.9 |
| Betaine | | | | | |
| Propanediol | 2.2 | 4.3 | | | 2.2 |
| Octan-1-ol, | | 2.2 | 2.2 | 2.2 | |
| Ethoxylated | | | | | |
| Glycerin | 4.3 | 4.3 | 4.3 | 4.3 | 4.3 |
| Flaxseed Oil | | | 1.1 | | |
| Saccharide | | | | 1.1 | 1.1 |
| Isomerate | | | | | |
| Cellulose Fiber | 7.6 | 7.6 | 7.5 | 7.5 | 7.5 |
| Pullulan | 27 | 27 | 26.9 | 26.9 | 26.9 |
| Water | 4 | 4 | 4 | 4 | 4 |

### Example 6

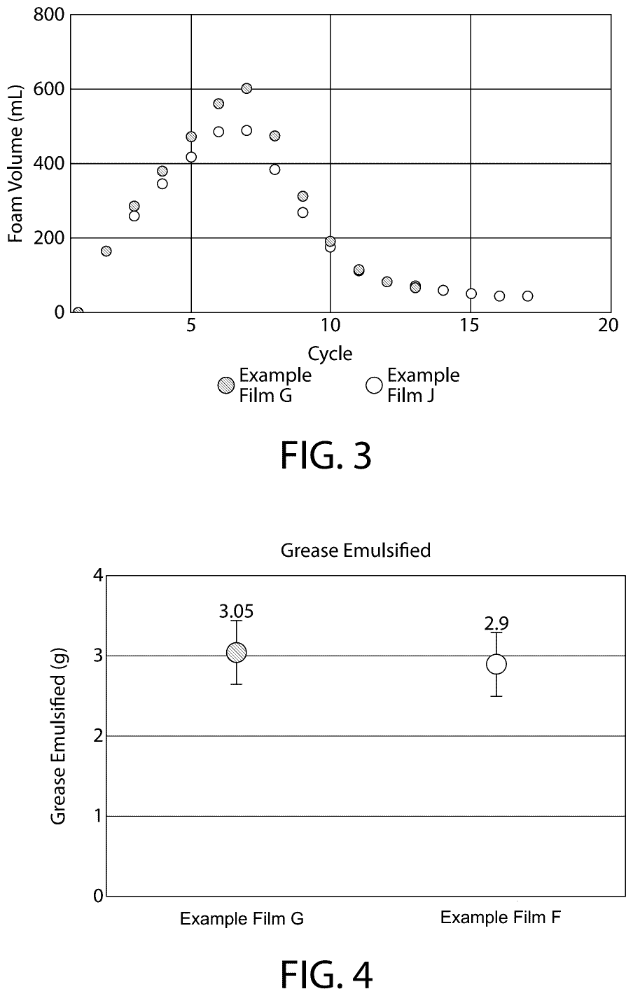

Example Films G and J were evaluated to assess their capability of emulsifying grease as well as their foaming ability. Cleaning solutions were prepared from Example Films G and J by dissolving Example Films G and J in an amount of water to achieve a cleaning solution having 0.02 wt. % of active ingredient (e.g., surfactants). A SITA device was then used to produce foam by stirring the cleaning solutions cyclically and measuring the amount and duration of the foam produced therefrom. After five cycles, a blend of olive oil, tallow, and butter in equal amounts was injected into the cleaning solution. The amount of emulsified fatty mixture (namely, olive oil, tallow, and butter) was then measured. A summary of the results of the foam measurements and the emulsification measurements are shown in FIGS. 3 and 4, respectively.

### Example 7

Two example home care compositions (Example Films K and L) were prepared in the form of films. The formulation for Example Films K and L are shown below in Table 4. This film is an example of a cleansing formulation.

TABLE 4

| | Example | Example |
|---|---|---|
| | Film K | Film L |
| | (wt. %) | (wt. %) |
| Sodium Lauryl Ether Sulfate | 28.4 | 32.4 |
| Propanediol | | 18 |
| Octan-1-ol, Ethoxylated | 15.8 | |
| Glycerin | 6.4 | |
| Pullulan | 48.2 | 48.2 |
| Fragrance | 0.9 | 1 |
| Water | 0.3 | 0.3 |

### Example 8

Example Film K was evaluated in comparison to a comparative liquid cleaning composition (Comparative Composition 2) to assess its ability to remove hydrophobic substances. The formulation for Comparative Composition 2 is provided in Table 5.

TABLE 5

| | Comparative |
|---|---|
| | Composition 2 |
| | (wt. %) |
| Water | 98 |
| Sodium Dodecyl | 0.8 |
| Benzene Sulfonate | |
| Sodium Citrate | 0.05 |
| Fragrance | 0.7 |
| C9-11 Pareth-8 | 0.4 |
| Glutaral | 0.05 |
| Color | 0.005 |
| Salts | 0.03 |

The contact angles of Example Film K and Comparative Composition 2 were determined by producing a cleaning solutions having 0.01 wt. % of surfactants according to procedures similar to those discussed in Example 7. The contact angle was then evaluated using a Drop Shape Analyzer DSA25 (Krüss), in which a drop shape of the respective cleaning solution is analyzed when in contact with a soiled surface (in this case Tile DM-90: Melamine with colored beef tallow). The lower the contact angle, the bigger the potential to remove grease.

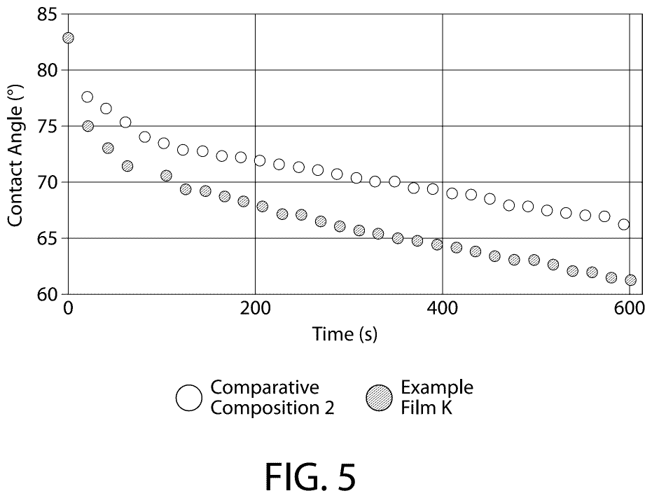

FIG. 5 is a bar graph of the contact angle of the cleaning solutions formed from Example Film K and Comparative Composition 2. As seen in FIG. 5, Example Film K has a lower contact angle, which indicates that Example Film K exhibited a superior ability to remove hydrophobic substances than Comparative Composition 2.

What is claimed is:

1. A home care composition comprising:
a polysaccharide comprising a pullulan, an alginate, or a combination thereof;
optionally, a cellulose;
a polyol;
one or more surfactant comprising an anionic surfactant, a betaine surfactant, a nonionic surfactant, or a combination of two or more thereof;
optionally, a fragrance; and
optionally, an emollient,
wherein the home care composition is in the form of a film.

2. The home care composition according to claim 1, wherein the polysaccharide is present in an amount from about 3 to about 21 wt. %, based on the total weight of the home care composition.

3. The home care composition according to claim 1, wherein the polysaccharide further comprises chitosan, maltodextrin, pectin, xanthan gum, guar gum, gum arabic, algin, or a combination of two or more thereof.

4. The home care composition according to claim 1, wherein the cellulose is a cellulose fiber.

5. The home care composition according to claim 1, wherein the cellulose has a diameter of about 1 micron to about 100 μm.

6. The home care composition according to claim 1, wherein the cellulose is selected from the group consisting of microcrystalline cellulose, hydroxypropylcellulose, hydroxypropylmethylcellulose, hydroxyethylcellulose, methylcellulose, carboxymethylcellulose, sodium carboxymethylcellulose, and a combination of two or more thereof.

7. The home care composition according to claim 1, wherein the polyol is present in an amount from about 1 to about 30 wt. %, based on the total weight of the home care composition, and wherein the polyol is selected from the group consisting of ethylene glycol, propylene glycol, butylene glycol, hexylene glycol, glycerin, diglycerin, diethylene glycol, and dipropylene glycol, and a combination of two or more thereof.

8. The home care composition according to claim 1, wherein the one or more surfactant is present in an amount from about 20 to about 70 wt. %, based on the total weight of the home care composition.

9. The home care composition according to claim 1, wherein the surfactant system comprising an anionic surfactant selected from sodium lauryl sulfate, sodium dodecyl sulfate, sodium lauryl ether sulfate, ammonium lauryl sulfate, ammonium laureth sulfate, and a combination of two or more thereof.

10. The home care composition according to claim 1, wherein the surfactant system comprises a betaine surfactant selected from cocoamidopropyl betaine, laurylamidopropyl betaine, and a combination thereof.

11. The home care composition according to claim 1, wherein the surfactant system comprises a nonionic surfactant selected from an alkyl polyglucoside, an alkoxylated alcohol, and a combination of two or more thereof.

12. The home care composition according to claim 11, wherein the nonionic surfactant comprises an alkyl polyglucoside(s) selected from the group consisting of lauryl glucoside, octyl glucoside, decyl glucoside, coco glucoside, caprylyl/capryl glucoside, sodium lauryl glucose carboxylate, and a combination of two or more thereof.

13. The home care composition according to claim 12, wherein the nonionic surfactant comprises an alkoxylated alcohol having about 1 to about 100 moles of an alkylene oxide per mole of alkoxylated alcohol.

14. The home care composition according to claim 11, wherein the nonionic surfactant comprises an alkoxylated alcohol selected from the group consisting of ethoxylated octan-1-ol, ethoxylated C₉₋₁₁ alcohols, C₁₁₋₁₅ pareth, PPG C₁₂₋₁₄ pareth, and a combination of two or more thereof.

15. The home care composition according to claim 1, wherein the home care composition has a weight ratio of anionic surfactant to amphoteric surfactant of about 1:1 to about 7:1.

16. The home care composition according to claim 1, wherein the home care composition has a weight ratio of anionic surfactant to nonionic surfactant of about 1:1 to about 4:1.

17. The home care composition according to claim 1, wherein the home care composition comprises an emollient selected from the group consisting of flaxseed oil, lanolin oil, lanolin alcohol, ceramide, caprylic/capric triglyceride, and a combination of two or more thereof.

18. A home care composition consisting of:
one or more cellulose;
one or more alginate;
one or more polyol;
one or more betaine surfactant;
optionally one or more anionic surfactant;
optionally one or more emollient;
optionally, one or more fragrance; and
optionally one or more preservative,
wherein the home care composition is in the form of a film.

19. A home care composition consisting of:
one or more cellulose;
one or more pullulan;
one or more polyol;
one or more betaine surfactant;
optionally one or more anionic surfactant;
optionally one or more emollient;
optionally, one or more fragrance; and
optionally one or more preservative,
wherein the home care composition is in the form of a film.

20. A pod comprising an outer film according to claim 19.
